(19) United States
(12) Patent Application Publication
(10) Pub. No.: US 2016/0204497 A1
(43) Pub. Date: Jul. 14, 2016

(54) INDUCTIVE PROXIMITY ANTENNA MODULE

(71) Applicant: YOUNG MAX ENTERPRISES CO., LTD., THE VALLEY (VG)

(72) Inventor: Chung-Ta WU, TAOYUAN CITY (TW)

(21) Appl. No.: 14/592,536

(22) Filed: Jan. 8, 2015

(51) Int. Cl. H01Q 1/22; G01S 13/00; G01V 3/12; H01Q 1/50

(52) U.S. Cl. CPC H01Q 1/22; H01Q 1/50; G01S 13/00; G01V 3/12

(57) ABSTRACT

An inductive proximity antenna module includes a substrate having opposing first and second peripheral sides, a sensing element mounted on the substrate with one end thereof disposed adjacent to the first peripheral side of the substrate, an antenna mounted on the substrate and electrically connected to the sensing element and extended from the sensing element in direction toward the second peripheral side of the substrate, and a sensing circuit mounted on the substrate and connected to the sensing element for detecting an environmental variation value in a near-field range by the sensing element.

### BACKGROUND OF THE INVENTION

1. Field of the Invention

The present invention relates to wireless radio-frequency module technology and more particularly, to an inductive proximity antenna module.

2. Description of the Related Art

Taiwan Patent I407632 discloses a radio-frequency device and a wireless communication device. This patent is characterized by the arrangement of the radiator of the antenna itself and a capacitive sensing element to detect an environmental capacitance value in a specific range.

This patent has indicated that the use of a metal receiver or inductor can affect the performance of the antenna, narrowing the operating frequency band, i.e., the bandwidth will be narrowed. Therefore, this patent mainly uses the radiator of the antenna for induction without providing any receiver or sensor.

Further, this patent has also indicated the use of a capacitance to block the transmission of a DC signal if there is a DC connection path between the radiator and the grounding element, preventing the capacitive sensing element from using the grounding element to detect an environmental capacitance value. On the contrary, if no any DC signal transmission path exits between the radiator and the grounding element, the capacitor can be omitted. In other words, the capacitor in the aforesaid patent is designed to block the transmission of a DC signal, however, it cannot affect the operating frequency of the radiator.

### SUMMARY OF THE INVENTION

The present invention has been accomplished under the circumstances in view. It is the present invention to provide an inductive proximity antenna module, which has the antenna located on a sensor, preventing the operating bandwidth of the antenna from the interference of the sensor.

To achieve object of the present invention, an inductive proximity antenna module in accordance with the present invention comprises a substrate, a sensing element, an antenna, and sensing circuit. The substrate has opposing first peripheral side and second peripheral side. The sensing element is mounted on the substrate, having one end thereof disposed adjacent to the first peripheral side of the substrate. The antenna is mounted on the substrate and electrically connected to the sensing element, and extended from the sensing element in direction toward the second peripheral side of the substrate. The sensing circuit is mounted on the substrate and electrically connected to with the sensing element for detecting an environmental variation value in a near-field range by means of the sensing element.

Thus, by means of connecting the sensing element and the antenna together, the inductive proximity antenna module of the invention can detect the approaching of an object and maintain the performance of the antenna.

Preferably, the inductive proximity antenna module further comprises a grounding element, a coupling element, and a matching element. The grounding element is mounted on the substrate. The coupling element is mounted on the substrate in a part of the sensing element and antenna and the grounding element. The matching element connects the grounding element and the coupling element for controlling the operating bandwidth of the antenna. Thus, the inductive proximity antenna module can control the operating bandwidth of the antenna by means of regulating the matching element.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating the structure of an inductive proximity antenna module in accordance with a first embodiment of the present invention.

FIG. 2 is a schematic drawing illustrating the structure of an inductive proximity antenna module in accordance with a second embodiment of the present invention.

### DETAILED DESCRIPTION OF THE INVENTION

The invention will now be described by way of examples with reference to the annexed drawings, in which the size and appearance of the component parts are used for explaining the technical features but not intended to limit the scope of the invention.

The inductive proximity antenna module can be used in any of a variety of electronic products having a wireless communication function, such as computer, cell phone, tablet computer, wearable electronic devices, etc. When used in an electronic product, the inductive proximity antenna module is electrically coupled to and controlled by the RF processor of the electronic product. The composition and structural features of the inductive proximity antenna module are outlined hereinafter.

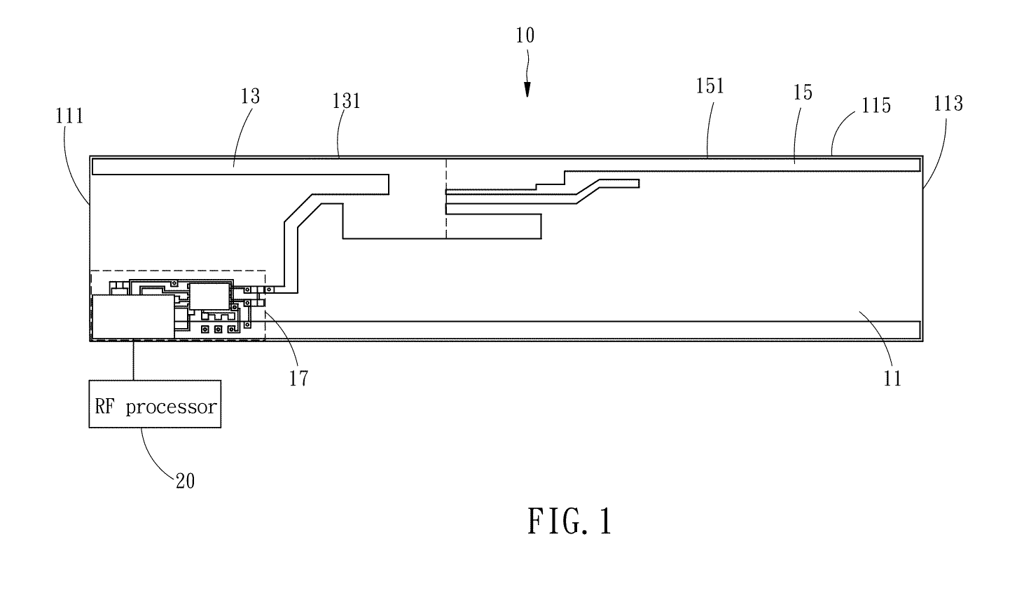

FIG. 1 illustrates a first embodiment of the inductive proximity antenna module in accordance with the present invention. As illustrated the inductive proximity antenna module 10 comprises a substrate 11, a sensing element 13, an antenna 15, and a sensing circuit 17.

The substrate 11 is normally a circuit board, comprising a first peripheral side 111 and an opposing second peripheral side 113.

The sensing element 13 is mounted on the substrate 11 with one end thereof kept in proximity to the first peripheral side 111 of the substrate 11.

The antenna 15 is mounted on the substrate 11 and electrically connected with the sensing element 13. Further, the antenna 15 extends from another end of the sensing element 13 in direction toward the second peripheral side 113 of the substrate 11. In the drawing, the broken line is adapted to divide the sensing element 13 from the antenna 15. Actually, this broken line does not exist.

The sensing circuit 17 is mounted on the substrate, and electrically connected with the sensing element 13 for sensing an environmental variation value in a near-field range by means of the sensing element 13. In this embodiment, the sensing circuit 17 is a position sensor IC. The sensing circuit 17 detects the environmental variation value by means of the sensing element 13, thereby determining whether there is any object approaching, such as human being, human limbs or body, etc.

In this embodiment, the environmental variation value to be detected by the sensing element 13 can be the capacitance or inductance value of the environment. Further, one peripheral side 131 of sensing element 13 and one peripheral side 151 of the antenna 15 are disposed in proximity to a third peripheral side 115 of the substrate 11 in a parallel relationship. Further, the third peripheral side 115 of the substrate 11 is connected with the first and second peripheral sides 111,113.

Further, after connection of the RF processor 20 of the electronic product with the inductive proximity antenna module 10 of the present invention, the RF processor 20 can generate a RF signal that is receivable and transmittable by the antenna 15. Further, the sensing circuit 17 receives the detected environmental variation value from the sensing element 13, and then transmits it to the RF processor 20, enabling the RF processor 20 to regulate the power of the RF signal according to the environmental variation value, i.e., when an object approaches the inductive proximity antenna module 10, the RF processor 20 lowers the power of the RF signal, avoiding impact on human health. Further, the antenna still can achieve the original transmitting and receiving functions by means of the power reduced RF signal without affecting the operating frequency and bandwidth.

In the same manner, when the object is moved far away from the inductive proximity antenna module 10, the sensing element 13 detects no environmental variation value, thus, the RF processor 20 provides the RF signal at the normal power level. Further, in this embodiment, the sensing element 13 and antenna 15 of the inductive proximity antenna module 10 are made in integrity and directly formed on the substrate 11. Therefore, in actual application, the sensing element 13 can be a part of the antenna 15, achieving transmitting and receiving of the RF signal.

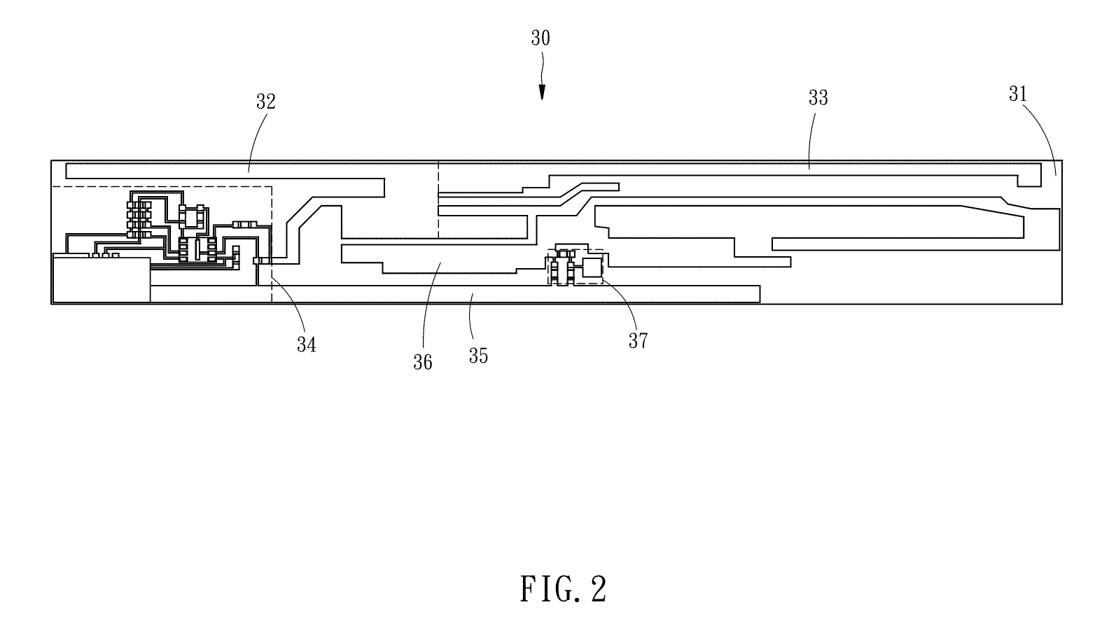

Referring to FIG. 2, an inductive proximity antenna module 30 in accordance with a second embodiment of the present invention is shown. In addition to the composition of a substrate 31, a sensing element 32, an antenna 33 and a sensing circuit 34, this second embodiment further comprises a ground grounding element 35, a coupling element 36 and a matching element 37. The grounding element 35 is mounted on the substrate 31. The coupling element 36 is mounted on the substrate 31 between a part of the sensing element 32 and antenna 33 and the grounding element 35, forming a signal coupling with a part of the sensing element 32 and a part of the antenna 33. The matching element 37 connects the coupling element 36 and the grounding element 35, and adapted to adjust the bandwidth of the antenna 33. The matching element 37 is selected from the group of resistor, capacitor, inductor, and their combinations. Therefore, regulating the impedance value of the matching element 37 can control the operating bandwidth of the inductive proximity antenna module 30.

In conclusion, the inductive proximity antenna module of the invention has the sensing element connected to the sensing circuit to become a part of the antenna, further, the operating bandwidth of the antenna is free from the effects of the sensing element.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An inductive proximity antenna module, comprising:
a substrate comprising a first peripheral side and an opposing second peripheral side;
a sensing element mounted on said substrate, said sensing element having one end thereof disposed adjacent to the first peripheral side of said substrate;
an antenna mounted on said substrate and electrically connected to said sensing element, said antenna extending from another end of said sensing element in direction toward the second peripheral side of said substrate; and
a sensing circuit mounted on said substrate and electrically connected to said sensing element for detecting an environmental variation value in a near-field range by said sensing element.

2. The inductive proximity antenna module as claimed in claim 1, further comprising a grounding element, a coupling element and a matching element, said grounding element being mounted on said substrate, said coupling element being mounted on said substrate between said sensing element and said antenna, and said grounding element, said matching element connecting said grounding element and said coupling element for controlling an operating bandwidth of said antenna.

3. The inductive proximity antenna module as claimed in claim 2, wherein said matching element is selected from the group of resistor, capacitor, inductor, and their combinations.

4. The inductive proximity antenna module as claimed in claim 1, wherein said sensing element and one peripheral side of said antenna are disposed adjacent to a third peripheral side of said substrate in a parallel relationship, said third peripheral side of said substrate being connected with the first and second peripheral sides of said substrate.
